(19) United States
(12) Patent Application Publication
(10) Pub. No.: US 2013/0289451 A1
(43) Pub. Date: Oct. 31, 2013

(54) Muscle Relief Device and Method thereof

(71) Applicant: Michael Yu, Taipei (TW)

(72) Inventor: Michael Yu, Taipei (TW)

(21) Appl. No.: 13/783,315

(22) Filed: Apr. 30, 2013

Related U.S. Application Data
(60) Provisional application No. 61/640,064, filed on Apr. 30, 2012.

(51) Int. Cl. A61H 7/00

(52) U.S. Cl. CPC A61H 7/00
USPC 601/15; 601/134

(57) ABSTRACT

A muscle relief device comprises a main body, at least one sensor unit, at least one relief part and at least one control unit. The relief part including at least one massage unit for massaging muscles of a user. The sensor unit includes at least one contact sensor for detecting the contact area of the user. The control unit connects the relief part and the sensor unit, receiving a detected data from the sensor unit and controlling operation modes of the relief part. The relief part, the sensor unit, and the control unit are arranged on the main body.

### CROSS-REFERENCE TO RELATED APPLICATION

This application claims the benefit of U.S. Provisional Application No. 61/640,064, filed on Apr. 30, 2012 in the United State Patent and Trademark Office, the disclosure of which is incorporated herein by reference.

### BACKGROUND OF THE INVENTION

1. Field of the Invention

The present invention generally relates to muscle relief device, in particular to a muscle relief device capable of customizing the modes and memorizing the portion of the muscle needed to be relief.

2. Description of the Related Art

In modern society, many people have to bear unpleasant muscle pain due to overwork, anxiety, or overuse the muscle. To solve this problem, many massage machines/devices, such as massage bed, massage chair, foot massager were launched into the consumer market. Those machines have massage units and heat unit, which massage the muscle and warm up the muscle to lessen the hurt. Those machines have been predetermined several modes. For example, a conventional massage chair has mode 1 which massage the back muscle by weak vibration for 10 minutes with 39° C. and by pressing for 15 minutes with 39.5° C. and has mode 2 which massage the upper shoulder muscle by punching for 5 minutes with 48° C. also massage the hip muscle by vibration. The users can try to select different modes to relief their muscle pain

However, even the users can select different modes and try to let the machine approach the portion of the muscle they wish to operate, those conventional massage devices still cannot completely massage on the target muscle. The modes of the conventional devices are preset by the manufacture and the parameters thereof are hardly adjusted. This drawback may lead many people who need to be massaged on special portion disappointed. Besides, some deceases lead the painful feeling inevitable. Take scoliosis patients as an example. The patients' vertebral column (backbone) is bent in abnormal angle and the muscles close to the vertebral column are prone to overly stretch or contract. Since each scoliosis patient has his or her own abnormal angle of backbone, the portion of muscles the patient need to be massage is different. Therefore, the conventional muscle relief machines are not able to be customized for the users' need.

Therefore, it is necessary to develop a new muscle relief device which can not only be set the parameter value by the user, physician, or specialist, but the operation behavior of the muscle relief machine can also expand to other muscle relief device.

The above information disclosed in this Background section is only for enhancement of understanding of the background of the described technology and therefore it may contain information that does not form the prior art that is already known to a person of ordinary skill in the art.

### SUMMARY OF THE INVENTION

The primary objective of the present invention is to provide a device for muscle relief.

The invention, muscle relief device, comprises a main body, at least one sensor unit, at least one relief part and at least one control unit. The relief part including at least one massage unit for massaging muscles of a user. The sensor unit includes at least one contact sensor for detecting the contact area of the user. The control unit connects the relief part and the sensor unit, receiving a detected data from the sensor unit and controlling operation modes of the relief part. The relief part, the sensor unit, and the control unit are arranged on the main body.

The invention, muscle relief device, comprises a main body, a relief part, a connection unit, and a control unit. The relief part has at least one massage unit for massaging muscles of a user. The connection unit is connected with a database storing a plurality operation value for the relief part. The control unit connects the relief part and the database, receiving a operation value from the database and controlling operation modes of the relief part. The relief part and the control unit are arranged on the main body.

Based on the description, the present invention is able to be customized/personalized for the normal user or even a patient suffering muscle pains. Besides, the operation mode for muscle relief device can be transmitted to a server such that the user is able to enjoy the same mode by using other present invention.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is illustrated a line chart with few variables in a time schedule of the present invention operating on the specific portion of the user;

FIG. 2 is the first embodiment of the present invention used for a muscle relief scarf;

FIG. 3 is the second embodiment of the present invention used for a muscle relief bed;

FIG. 4 is the third embodiment of the present invention used for a muscle relief pillow;

FIG. 5 is the fourth embodiment of the present invention used for a muscle relief foot massager; and

FIG. 6 is the fifth embodiment of the present invention used for a muscle relief chair, connecting with a outside server.

### DETAILED DESCRIPTION OF THE PREFERRED EMBODIMENTS

Details of the objects, technical configuration, and effects of the present invention will be described more fully hereinafter with reference to the accompanying drawings, in which exemplary embodiments of the invention are shown. The like reference numerals indicate the like configuration throughout the specification, and in the drawings, the length and thickness of layers and regions may be exaggerated for clarity. The technical content of the present invention will become apparent by the detailed description of the following embodiments and the illustration of related drawings as follows. As used herein, the term “and/or” includes any and all combinations of one or more of the associated listed items.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

To alleviate the pain or stress of the muscles, the present invention provides a method and a device which can customize/memorize the portion of the body needed to massage, especially in a precise way. The concepts of present invention can be used in bed, massage chair, massage foot, helmet, necktie, scarf, pillow, etc. any object which directly/indirectly contacts the human body. It is good for scoliosis patient; any person whose particular muscles are necessary to massage to make them feel better.

Similarly, the massage units used for massage in the pain relief device can be replaced by heating unit, which gradually heat the human body in a customized temperature, especially in recommended by the specialist or the person per se. Also, the muscle relieve device can utilize both massage units and heat units. The combination may attain better effect.

The present invention may include, but not limit several components, the brief description of which shown as follows.

Main body: The main body of the present invention, which may apply to bed, massage chair, massage foot, helmet, necktie, scarf, pillow, etc.

Relief part(s): This has at least one massage unit and/or heat unit. The massage unit is able to grasp, hold, punch, press, tickle, and vibrate. The heat unit is used to warm up the muscle and let the muscle relax. The motion unit, controlled by the control unit, moves the massage unit and heat unit.

Sensor(s): This has contact sensors, weight sensors and an ID sensor. The contact sensors detect the contact area the user contact with the present invention. The weight sensors can detect partial and/or total weight of the portion of the user. The detection results will transmit to a control unit for calculation. The ID sensor is used for identified the person, for example, finger print sensor can be one of ID sensor. The user can also use carrier/key to the ID sensor for the present invention to identify. Identifying the user is help to retrieve the relief part operation mode which had been stored in the database.

Control unit(s): The controls the relief part. The operation of the relief part may derive from the calculation of control unit (the information is from sensor unit and measuring structure), or the previous stored operation value from database, which is arrange in the main body or server.

Database/Memory: This storing value for operate the massage units, heat units, and motion units. The database is arranged in the main body or a serve, or both. It may store several customized modes for unique user. Some modes have operation value input by the user; some modes have operation value input by the physician, or specialist, who intend to help the patient to relief specific portion of muscle of the patient in a specific and customized way. The database may also store the account information and password or other ID confirmation code corresponding to the account.

Measuring structure (s): This helps measure the human body, for example, what the length/width of leg/back/neck/thigh/ is. The results will also be transmitted to the control unit and database. The control unit has been preset some algorithm, the results from measuring structure will lead the control unit to operate the motion unit in an efficient way such that the massage unit or heat unit will not operate on non-contact body area.

Connection unit: This may refer to port or other wireless connection utilities. It will help to get the data from outside device, for example, USB storage device or database of a server. The data is related to the user preferable, useful, medical operation mode of the present invention. Besides, this can connect with a scanner. If a scoliosis patient inserts his/her X-ray film, compared with previous storage data which several operation value input by the physician, or specialist to help for massage and heat recommendation on the specific portion of the patients muscles will retrieve from the database into the control unit, and then the control unit will control the relief part to operation beneficial way to the patent.

Panel: This is a tool for the user, physician, or specialist to input some operation value.

There are variables (includes but not limited) to be customized in the present invention:

Time: massage units operation time (the present invention may have at least two massage units function in different time, for example, one in sporadic time to massage and another in almost continuous time; of course, they can use in same time schedule as well), heat units operation time (each heat unit may also have its time period, just like massage unit), the overlap time between massage units and heat units. The time schedule is determined by the preset operation value, which is stored in a database/memory in the present invention or download from other device.

Massage way: the massage units have different function, such as grasp, hold, punch, press, tickle, and vibrate. The function can be decided by the time schedule

Strength: it may or may not be corresponding to the Time schedule; the strength of grasping, holding, punching, pressing, tickling, vibrating, etc. can be decided by the time schedule.

Temperature—it may or may not be corresponding to the Time schedule; the maximum temperature of the heat units is determined under certain degree for safety concern.

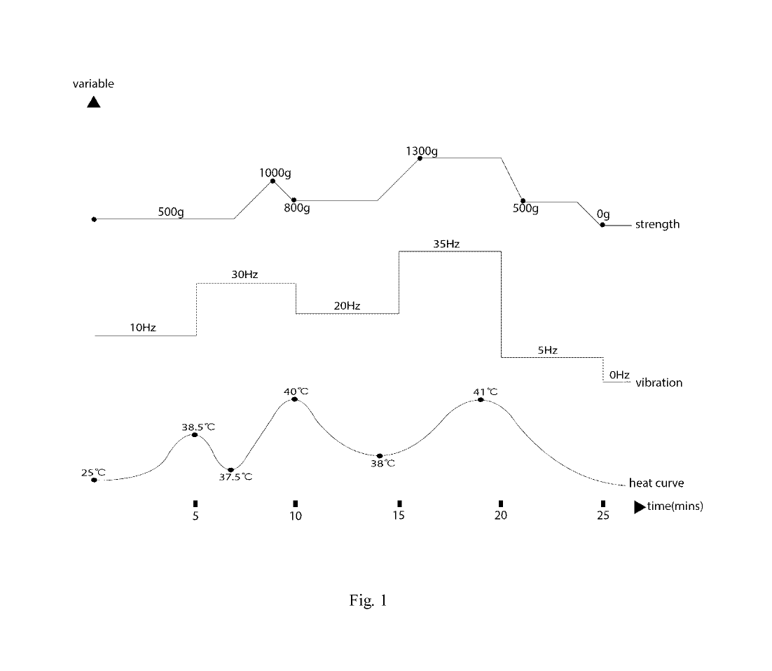

Please refer to FIG. 1. FIG. 1 is illustrated a line chart with few variables in a time schedule of the present invention operating on the specific portion of the user. This chart only shows a part of variable for demonstration purpose.

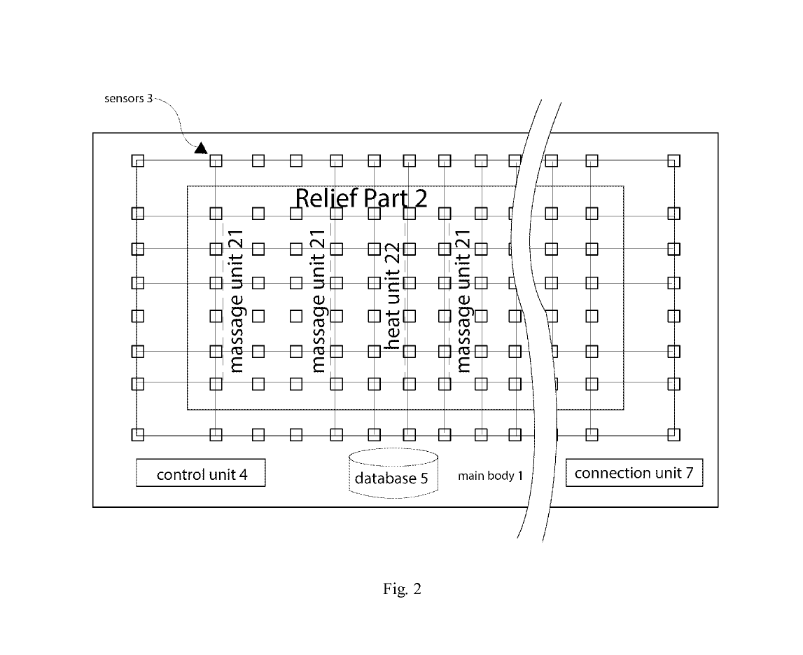

Please refer to FIG. 2. FIG. 2 is the first embodiment of the present invention used for a muscle relief scarf. In the first embodiment, the muscle relief device comprises a main body 1, relief part 2, a plurality of sensors 3, control unit 4, database 5 and connection unit 7. The main body 1 here is a scarf. The relief part has a plurality of massage units 21, heat units 22, and motion unit. The arrangement of massage units 21 and heat units are shown in FIG. 2 is for demonstration instead of limitation. The sensors 3 in the first embodiment are all contact sensors 31, which may shown as a mesh to detect the contact area the user contact with the present invention. The density of the contact sensors 31 is related to the precision of the detected results. The detected values are transmitted to the control unit 4 and the control unit 4, which may downloading some operation value from database 5, will calculate a preferable method for the relief part to operate. The preferable method includes a lot of instructions, such as the way the motion units 23 moving the massage units 21 and/or the heat units 22 areas, the strength of the massage units 21 and/or the temperature of the heat units 22. The connection unit 7 can accept outside operation value from other device which passes the customized value to the control unit for the present invention to operate. The contact sensors 31 may arranged on the surface of the main body 1 to directly contact with the user or hidden in a thin layer of the scarf. It is noted that the in the first embodiment, the contact sensor 31 is located above the relief parts 2. However, in actual practice, the locations of relief part 2 and the sensor 3 are not limited. It is also possible relief part 2 is above the sensors 3 because the contact sensors 31 of the sensor 3 are able to detect the user's body via indirect contact, such as infrared sensor.

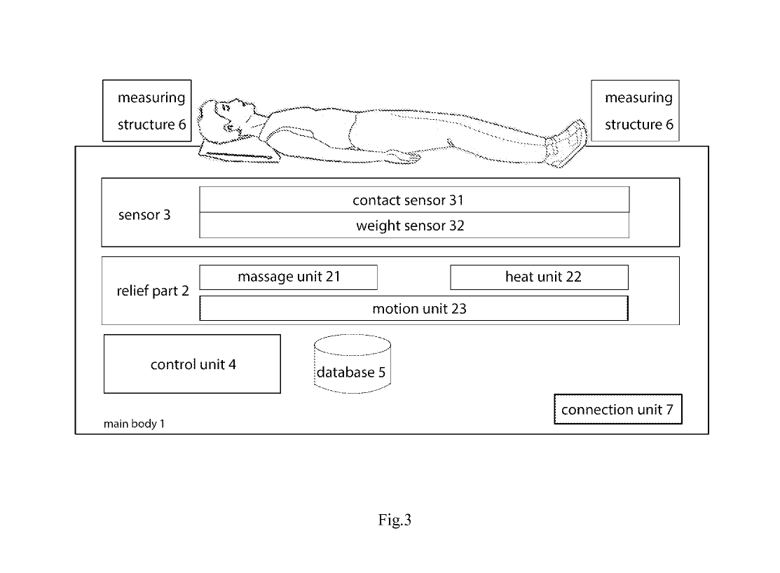

Please refer to FIG. 3. FIG. 3 is the second embodiment of the present invention used for a muscle relief bed. In the second embodiment, the muscle relief device comprises a main body 1, relief part 2, a plurality of sensors 3, control unit 4, database 5, measuring structure 6 and connection unit 7. The main body 1 in this embodiment is a bed. The location of the relief part 2 and the sensors 3 are shown in FIG. 3 is for demonstration. The relief part 2 has a plurality of massage units 21 and heat units 22. The sensors 3 in the second embodiment include contact sensors 31 and weight sensors 32. The contact sensors 31 may similar to those of the first embodiment. The weight sensors 32 are plural and used for weigh the partial weight of the user, such as how much weight the leg or arm is. The contact sensors 31 and the weight sensors 32 may be arranged in separate location. The detected values from contact sensors 31 and weight sensor 32 are transmitted to the control unit 4 and the control unit 4, which may downloading some operation value from database 5. The measuring structure 6 measure the human body, for example, what the length/width of leg/back/neck/thigh/ is and pass the detected value to the control unit 4 as well. Via the sensors 3 and measuring structure 6, the present invention are able to build a rough blueprint of the user's fundamental back contour of the body and the detected value will help the present invention to calculate more precise way for the relief part 2 to operate. In addition, the detected value may be valuable for the physician or specialist for reference. In the second embodiment, the sensors may also include an ID sensor which may help to identify the user. If the user has previously set a preferable mode in the present invention, the present invention is able to operate a favorable operation. It is noted that the arrangement of the relief part 2, sensors 3, and measuring structure are only for demonstration; those arrangement may not limited for the present invention.

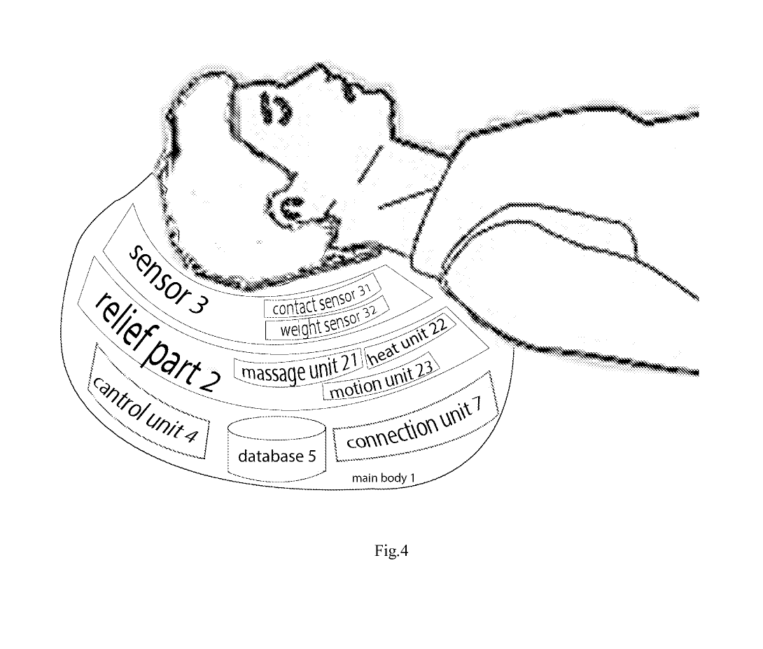

Please refer to FIG. 4. FIG. 4 is the third embodiment of the present invention used for a muscle relief pillow. The principle of the components is similar to the second embodiment. In the third embodiment, the main body 1 is a pillow and suitable for user's head to lay down.

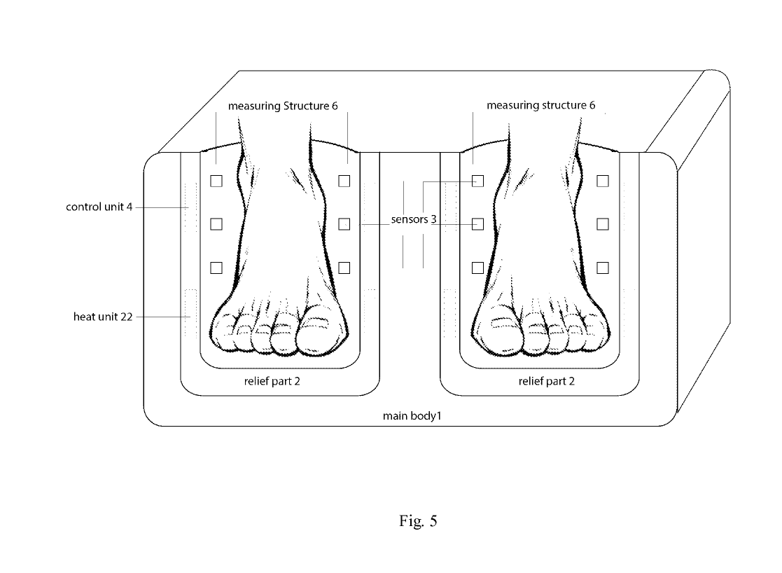

Please refer to FIG. 5. FIG. 5 is the fourth embodiment of the present invention used for a muscle relief foot massager. The principle of the components is similar to the second embodiment.

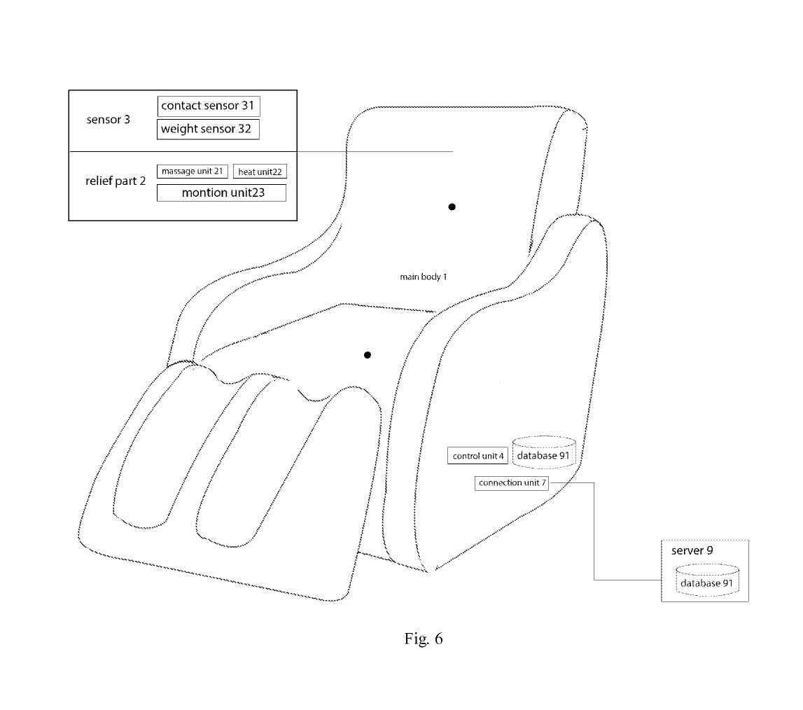

Please refer to FIG. 6. FIG. 6 is the fifth embodiment of the present invention used for a muscle relief chair, connecting with an outside server 8. The principle of the components is similar to the second embodiment. The data for operation (operation value) is able to download from the outside device, such as server. The operation mode could also be transmitted to the database 91 of the server 9 for record. The user can use other present invention (may be simplified invention, such as the present invention without sensor) to enjoy the same mode in different place. It is noted that the any type of the present invention, such as pillow, scarf, bed, chair, helmet is able to connect the database 91 of the server 91, transmitting the detected value or preferable mode (operation value) or receiving the preset operation value.

There are several methods to customized muscle relief device. The three methods shown below are for demonstration and do not limits the scope of present invention.

Method 1:

Detect the Body by the Sensors:

Take bed for example. The muscle relief includes at least one sensor (module) which can detect the weight per area. It also get the total weight of the human body, by means of input from the user or weight by the weight sensor(s) of the device it is included. Since the body laying on the bed comprises with contact sensor(s), which may detect the total area the human body contact. By means of the total area, total weight, weight per area corresponding to the portion of the body, the present invention can calculate those detected value by a control unit; the control unit send the instruction to the massage unites/heat units/motion units to operate.

Method 2:

Use the value stored in the memory/database of the device or any other storage device. The value transmitted into control unit, assisting the control unit to operate the massage units or heat units. The values can be determined by a physician, who saw the X-ray film of the body and offer value(s) which help the operation of the massage units. Or based on the users' previous experience (the user could use “record” function of the present invention to record the preferable procedure). Another way to store the value is to store the data into a “key/carrier”, for example, USB or other storage device. The present invention has at least one port. When the key/carrier insert into the port, the data will be read and the control unit of the present invention will operate based on the value/data of the storage device. The carrier may also be used for ID confirmation tool.

Method 3: Store the Data by Server

This can be applied to business. When a user going outside and see the invention, for example, a chair for massage, he sits on it and pay a coin for exchanging a massage service by the present invention. The machine can download the data by a Server, the user only need to press some code on the panel or use fingerprint to help the machine to know what the mode should it use (The server will know verify the user and transmit the corresponding values.). Therefore, if the present inventions are set in the whole country and connect to the internet/internal network, the user can get customized service without bring any stuff to notify the machine.

The embodiments and the technical principles used are described above. All variations and modifications of the present invention and the uses thereof are included in the scope of the present invention if they do not depart from the spirit of the disclosure of this specification and drawings.

What is claimed is:

1. A muscle relief device, comprising:
a main body;
at least one relief part including at least one massage unit for massaging muscles of a user;
at least one sensor unit including at least one contact sensor for detecting the contact area of the user; and
a control unit connecting the relief part and the sensor unit, receiving a detected data from the sensor unit and controlling operation modes of the relief part;
wherein the relief part, the sensor unit, and the control unit are arranged on the main body.

2. The muscle relief device of claim 1, wherein the relief part further includes at least one heat unit controlled by the controlled by the controlled unit.

3. The muscle relief device of claim 1, wherein the sensor unit further includes a weight unit for weighing the portion of the body of the user and the detected value from the weight unit was received by the control unit.

4. The muscle relief device of claim 1, wherein the muscle relief device further comprise a measuring structure to detect the portion of body shape and the detected value from the measuring structure was received by the control unit.

5. The muscle relief device of claim 1, wherein the muscle relief device further comprise at least one motion unit controlled by the control unit for moving the at least one massage unit.

6. The muscle relief device of claim 1, wherein the muscle relief device further comprise at least one database storing the detected value.

7. The muscle relief device of claim 6, wherein the database further stores information of the account of the user.

8. The muscle relief device of claim 7, wherein the sensor unit further includes an ID sensor sensing the a portion of body feature from the user, and the account information includes a pre-stored body feature data and user massage modes, and the body feature information from ID sensor is compared with the pre-stored body feature data and if the identification of the user is confirmed, the control unit will adopt at least one of the user massage modes.

9. The muscle relief device of claim 1, wherein the muscle relief device further comprises at least one connection unit for transmitting or receiving data from other devices.

10. The muscle relief device of claim 9, wherein the muscle relief device further comprises a ID sensor for identifying the user, the connection unit is connected with a server having a database, if the user identification is confirmed, an operation value from the database of the server will be sent to the control unit.

11. The muscle relief device of claim 9, wherein the muscle relief device further comprises a ID sensor for identifying the user, the connection unit is connected with a server having a database, if the user identification is confirmed, the detected value from the sensor unit will be sent to the sever.

12. The muscle relief device of claim 1, wherein the muscle relief device further comprise a panel for inputting operation values for presetting, adding or adjusting the operation modes for the control unit.

13. A muscle relief device, comprising:
a main body;
a relief part having at least one massage unit for massaging muscles of a user;
a connection unit connected with a database storing a plurality operation value for the relief part; and
a control unit connecting the relief part and the database, receiving a operation value from the database and controlling operation modes of the relief part;
wherein the relief part and the control unit are arranged on the main body.

14. The muscle relief device of claim 13, wherein the database is arranged in a server, and the server stores users account information.

15. The muscle relief device of claim 14, wherein the muscle relief device further comprises at least one sensor unit.

16. The muscle relief device of claim 15, wherein the sensor unit further includes an ID sensor sensing the a portion of body feature from the user, and the account information includes a pre-stored body feature data and user massage modes, and the body feature information from ID sensor is compared with the pre-stored body feature data and if the identification of the user is confirmed, the control unit will adopt at least one of the user massage modes.

17. The muscle relief device of claim 15, wherein the sensor units includes at least one contact sensor for detecting the contact area of the user.

18. The muscle relief device of claim 13, wherein the relief part further includes at least one heat unit controlled by the controlled by the controlled unit.

19. A method of a device to relief muscle, comprising:
a. Sensing the area of contact portion of the user via sensor to produce a detected value;
b. Referring the detected value and calculating or selecting a operation mode by a control unit; and
c. Operation the operation mode by a relief part.

20. The method of claim 19, further comprising identifying a user identity for using the operation mode related to the user.
